(19) United States
(12) Patent Application Publication
(10) Pub. No.: US 2014/0239017 A1
(43) Pub. Date: Aug. 28, 2014

(54) DISPENSER FOR PASTE-LIKE MATERIALS

(71) Applicant: Alfred Von Schuckmann, Kevelaer (DE)

(72) Inventor: Alfred Von Schuckmann, Kevelaer (DE)

(21) Appl. No.: 14/347,031

(22) PCT Filed: Oct. 4, 2012
(86) PCT No.: PCT/EP2012/069638

§ 371 Date: Mar. 25, 2014

(30) Foreign Application Priority Data
Oct. 5, 2011 (DE) 202011051538.9

(51) Int. Cl. B65D 37/00

(52) U.S. Cl. CPC B05B 11/309
USPC 222/207; 222/256

(57) ABSTRACT

The invention relates to a dispenser (1) for pasty substances (11), consisting of a tubular substance housing (2) having a follower plunger (7) and a hand-actuatable headpiece (3) which is equipped with a mouthpiece and is linearly guided for dispensing the substance and can be depressed in the direction of the follower plunger (7) while tensioning a return spring element (25) that structures itself by buckling. In order to provide a dispenser for pasty substances that, in particular, has improved function of the return spring element compared with the prior art and can be produced in a cost-effective manner, it is proposed that the middle portion (29) of the resilient return spring element (25) folds up into the portioning chamber (18) of the headpiece (3), the return spring element (25) transitioning from a curved S-shape into the shape of two oppositely oriented U-portions (33, 33′), and the two end portions (28, 30) being clamped at the headpiece (3) and at an upper tube part (9) of the substance housing (2).

The invention relates to a dispenser for pasty substances, consisting of a tubular substance housing having a follower plunger and a hand-actuatable headpiece which is equipped with a mouthpiece and is linearly guided for dispensing the substance and can be depressed in the direction of the follower plunger while tensioning a return spring element that structures itself by buckling.

Dispensers of the kind in question are known. They serve in particular for dispensing apportioned pasty substances, for example, for dispensing creams, for instance, care creams or toothpaste, a follower plunger being provided in a container that stores the substance, and the substance being dispensed by pumping movements of the headpiece. In this context, reference is made, for example to U.S. Pat. No. 4,949,876. From this patent, a dispenser of the kind in question is known in which by user-actuated lowering of the headpiece for dispensing the substance, a return spring element that is secured between the headpiece and the substance housing is tensioned as a result of the buckling of said return spring element. Upon discontinuance of the compressive load acting via the user on the headpiece, the latter is displaced back into the initial position due to the previously built-up return spring force of the return spring element. From U.S. Pat. No. 4,336,895, a dispenser is known which, for dispensing the substance, is actuated by the user by means of a lever that is provided at the headpiece in a displaceable manner and that tensions a return spring element provided in the headpiece by way of buckling the return spring element.

Proceeding from the above-described prior art, it is an object according to an aspect of the invention to provide a dispenser for pasty substances, the function of which is improved with respect to the prior art and which can be produced in a cost-effective manner. Further aspects are specified with regard to further features of the invention, as set forth below. They can be of importance independently but also additionally with regard to the already mentioned object.

According to a first solution concept, this object is achieved in that the middle portion of the resilient return spring element folds up into the portioning chamber of the headpiece, the return spring element transitioning from a curved S-shape into the shape of two oppositely oriented U-portions, and the two end portions being clamped at the headpiece and an upper tube part of the substance housing. As a result of the proposed configuration, the return spring element that buckles in the course of a preferred downward movement of the headpiece acts in an advantageous manner on the substance that is pre-portioned in the portioning chamber for dispensing. By folding up the at least one middle portion of the resilient return spring element into the portioning chamber, dispensing the substance from the positioning chamber is preferably supported by the mouthpiece. Here, with regard to a vertical section through the return spring element, the wall of the return spring element preferably transitions during a preferably completely loaded headpiece position, i.e., a preferably completely lowered headpiece position, from a curved S-shape in the unloaded headpiece position into a double, oppositely oriented U-shape, it being furthermore preferred that at least the middle portion, moreover preferably at least a resulting U-portion, also plunges into the portioning chamber thereby acting on the substance. Here, in particular in a further preferred rotational configuration of the return spring element with regard to a vertical section through the return spring element, a radially outer end portion of the latter is fixed to the headpiece, and a radially inner end portion is fixed to an upper tube part of the substance housing, in particular by means of clamping. Accordingly, clamping is preferably achieved in the region of the U-legs of the oppositely oriented U-portion, which U-legs, in a vertical section, face away from one another in the loaded position. With regard to a vertical section through the return spring element, the telescopic-bellows-like return spring element preferably has a wall with a curved S-shape when the return spring element is in a relaxed solo position, i.e., when it is not mounted in the dispenser. In an alternative configuration, the curved S-shape of the return spring wall is achieved in the mounted state, more preferably as a result of adequate clamping between the headpiece and the substance housing so that even in an unloaded basic position of the headpiece, at least a low reset force of the return spring element still acts on the headpiece.

Further features of the invention are described and illustrated below, also in the description of the figures, often in their preferred association with the subject matter of claim 1 or features of further claims. However, they may also be of importance in association with only individual features of the claim 1 or the respective further claim, or in each case independently.

Thus, in first instance, it is further preferred that the outer end portion of the return spring element that folds up from the S-shape extends further so as to form a cover tongue for an outlet opening between the portioning chamber at the headpiece and the outlet mouthpiece, for forming an outlet valve. Accordingly, at least when viewed prior to inserting the return spring element into the dispenser, the cover tongue preferably forms a partial vertical extension of the preferably radially outer end portion of the curved S-wall. Furthermore, in this regard, the material thickness of the cover tongue is reduced at least with respect to the outer end portion of the return spring element so as to provide advantageous bending properties of the cover tongue for moving it in a release position when actuating the dispenser.

The outlet valve, preferably with the cover tongue protruding into the mouthpiece channel, interacts with an outlet opening of the portioning chamber, it being further preferred that in the closing position, the cover tongue is flatly engaged on a headpiece surface that surrounds the outlet opening. It is preferred in this regard that the outlet valve or the cover tongue is resiliently loaded in the direction of the outlet opening between the portioning chamber and the outlet mouthpiece. In a preferred configuration, the spring load results from the selected material of the outlet valve. For this, the engagement surface surrounding the dispense opening is preferably inclined in the mounting position of the return spring element and therefore also of the outlet valve or the cover tongue, preferably inclined at an angle of from 5 to 7 degrees to a vertical so that the cover tongue is also inclined in the closed position out of the initial vertical orientation radially outwards about a pivot/buckling region in the foot region of the cover tongue at the outer end portion of the return spring element. As a result of this, the cover tongue is biased in the direction towards the engagement surface of the dispense opening of the portioning chamber. As a result of a pressure increase due to a downward displacement of the headpiece and the substance flowing out of the portioning chamber at the same time, the cover tongue, while lifting off from the engagement surface and accordingly uncovering the outlet opening, is further pivoted in the direction towards the mouthpiece channel and thereby preferably is displaced in a bow-like manner so that in the course of dispensing the substance, the cover tongue hangs in the substance flow and is bent.

According to a preferred configuration it is provided that an inlet valve is provided that operates alternately with the outlet valve and, during a suction stroke, opens the portioning chamber for filling, and that the inlet valve is formed as one piece with the return spring element. Such an inlet valve is preferably made from rubber-like, elastically returnable plastics. In this regard, it is a further preferred possibility that the return spring element consists of rubber-like, elastically returnable plastics, whereby, as further preferred, a one-piece configuration of the outlet valve with the spring element is possible and, as further preferred, at the same time, a one-piece configuration of the inlet valve with the return spring element is possible. This preferred configuration of the return spring element as one piece, preferably with both the outlet valve and the inlet valve, proves to be particularly cost-effective as far as production is concerned and, moreover, it is also cost-effective with regard to the assembly of the dispenser. The return spring element is preferably made from an elastically returnable elastomer and, furthermore, in particular from a silicone material. This material provides sufficient recovery properties for resiliently displacing the headpiece back into the initial position. The return spring element is preferably produced here as an injection molded part. By forming the return spring element from such a plastics material, in particular silicone, the configuration of the return spring element, in which preferably only a middle portion extends freely between the clamped end portions, proves to be of advantage to the effect that this results in a diffusion area as small as possible, this is furthermore in particular the case if the return spring element, as further preferred, is a boundary for the portioning chamber at least in certain sections. Accordingly, in the case of such a configuration, that surface of the return spring element that faces towards the portioning chamber is covered with the substance, at least after the first use of the dispenser. The material preferably used for the return spring element is diffusible. As a result of the above-described configuration of the return spring element—and this is further preferred the case in any vertical position of the headpiece—only the middle portion that freely extends between the clamped end portions is free and, accordingly, is not covered with material. Accordingly, the diffusion area is limited only to this middle portion. It is further preferred that the additionally provided portions of the return spring element, in particular viewed in the direction of diffusion, are backed with material of the substance housing, the headpiece and/or the tube part so that here a diffusion barrier is in place, or they are covered on both sides with substance, at least after a first use of the dispenser.

The invention is explained below with reference to the accompanying drawing, which, however, shows only an exemplary embodiment. In the drawings:

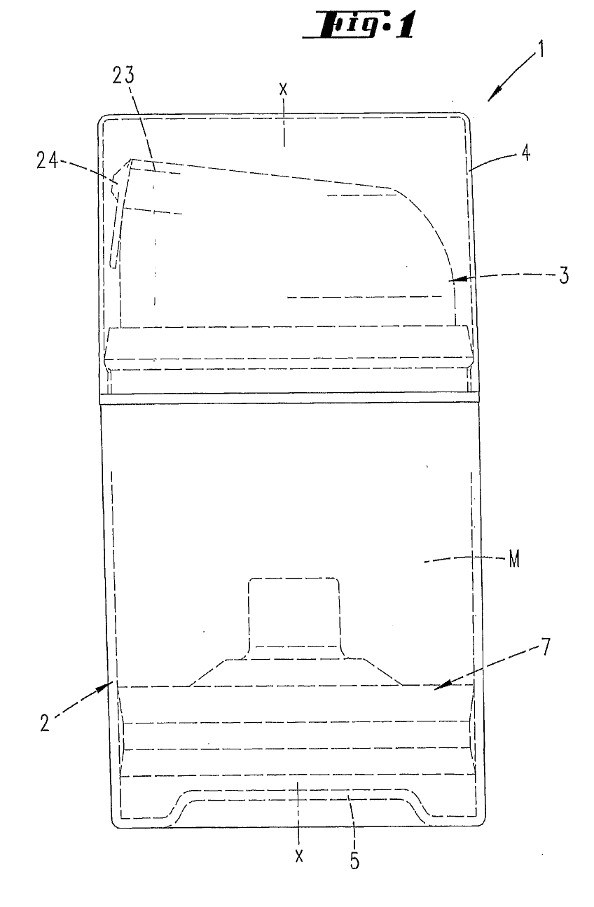

FIG. 1 shows a side view of the dispenser with a cap;

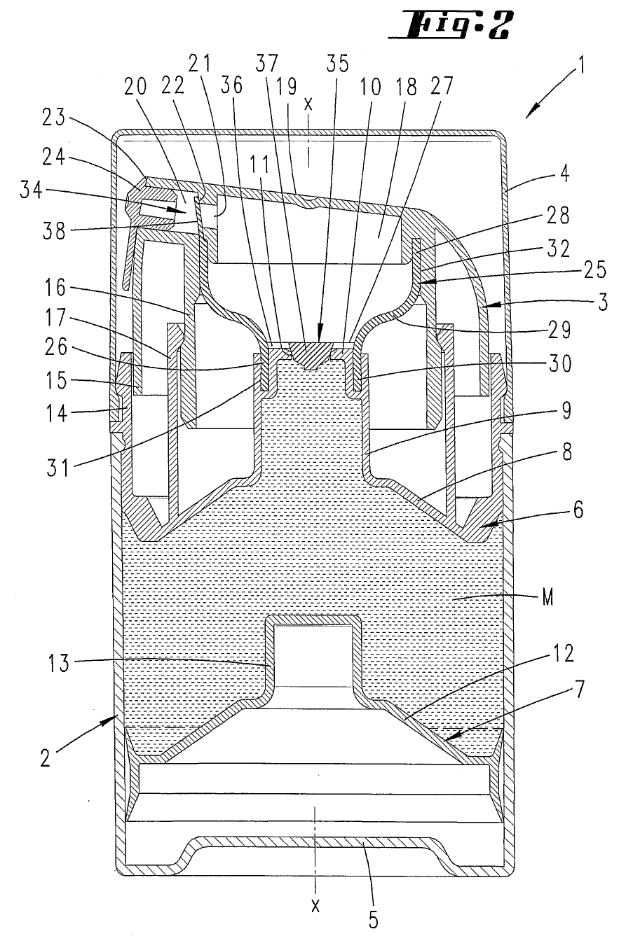

FIG. 2 shows the vertical section through the dispenser, relating to a first use of the same;

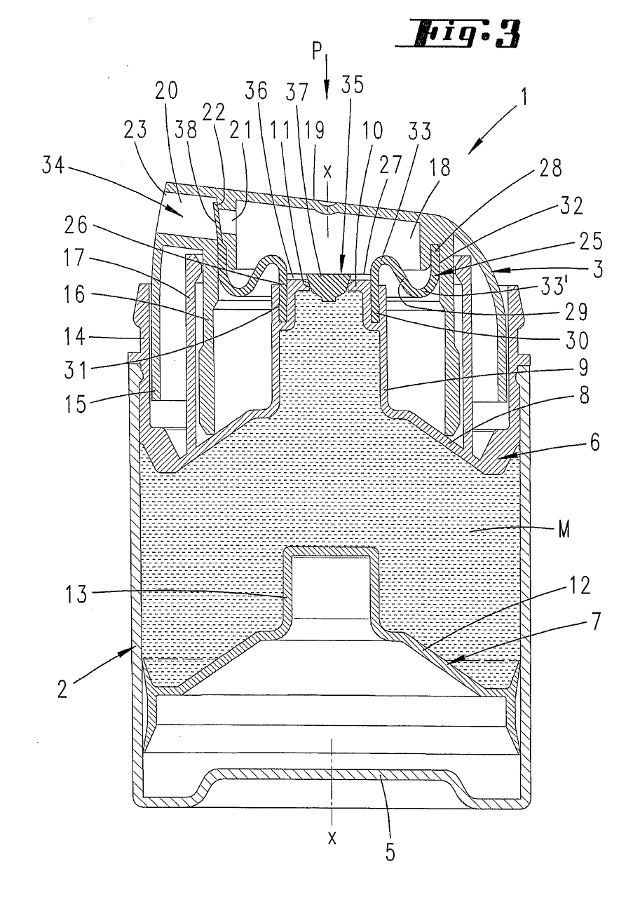

FIG. 3 shows an illustration corresponding to FIG. 2, but after removal of the cap and of a plug that closes a mouthpiece channel of the dispenser prior to a first use, relating to an intermediate position in the course of a displacement of a headpiece for actuating the dispenser;

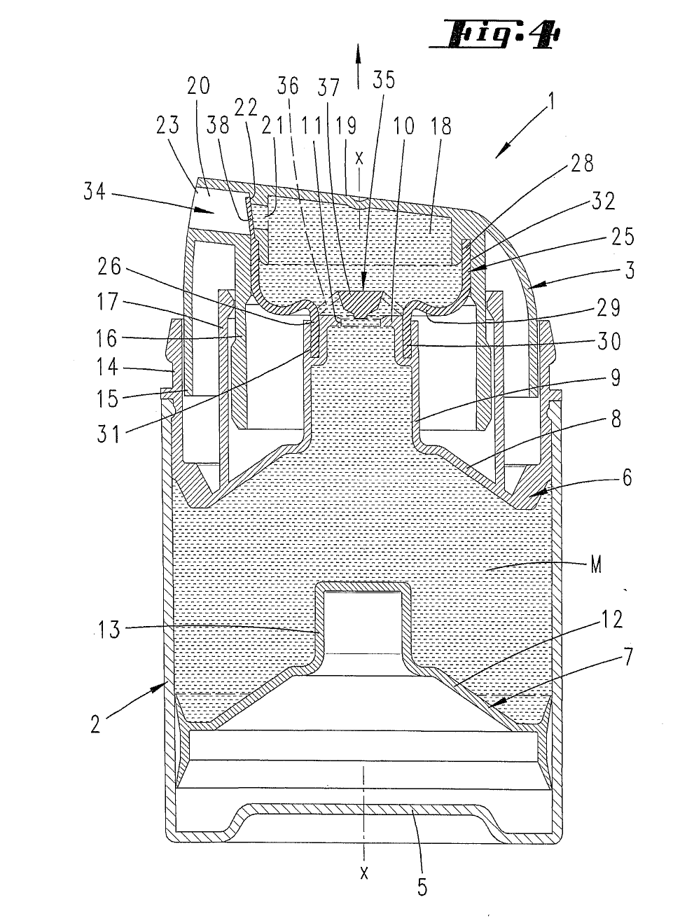

FIG. 4 shows an illustration corresponding to FIG. 3, relating to an intermediate position in the course of the displacement of the headpiece back into the initial position;

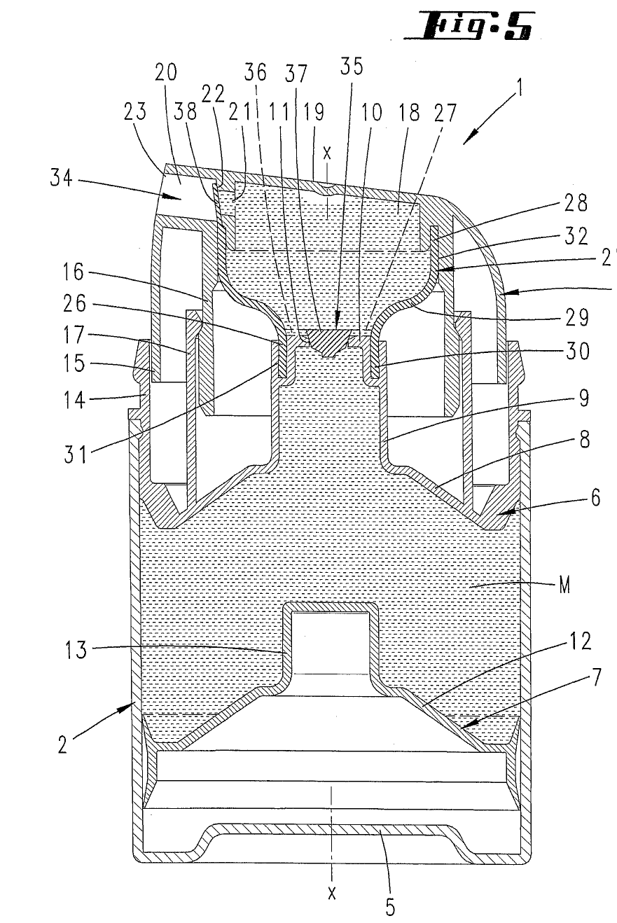

FIG. 5 shows an illustration subsequent to FIG. 4, relating to the headpiece displaced back into the end position, during the first filling of a portioning chamber;

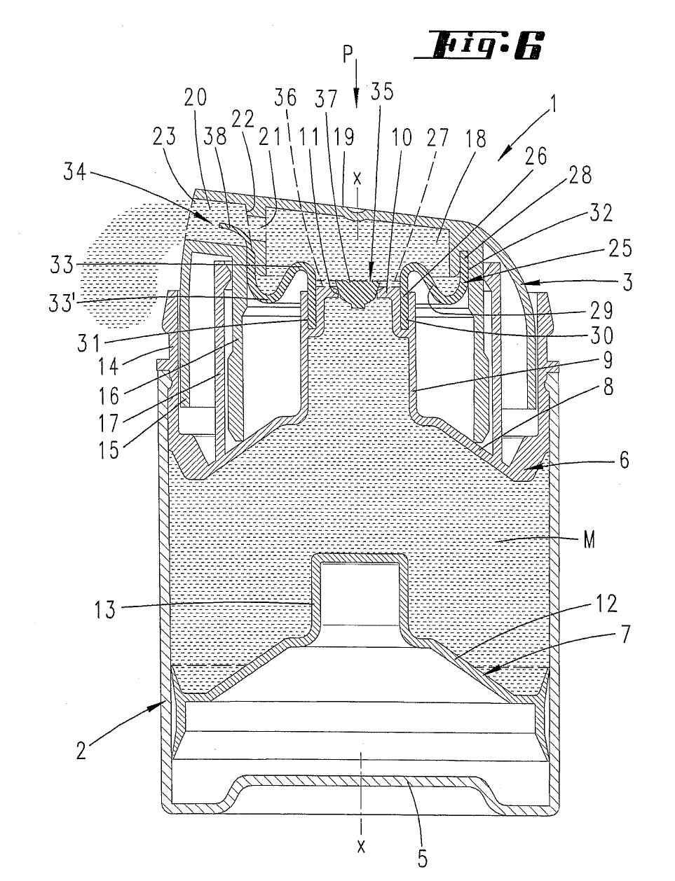

FIG. 6 shows an illustration corresponding to FIG. 3, but during the dispensing of the substance achieved here by filling the portioning chamber;

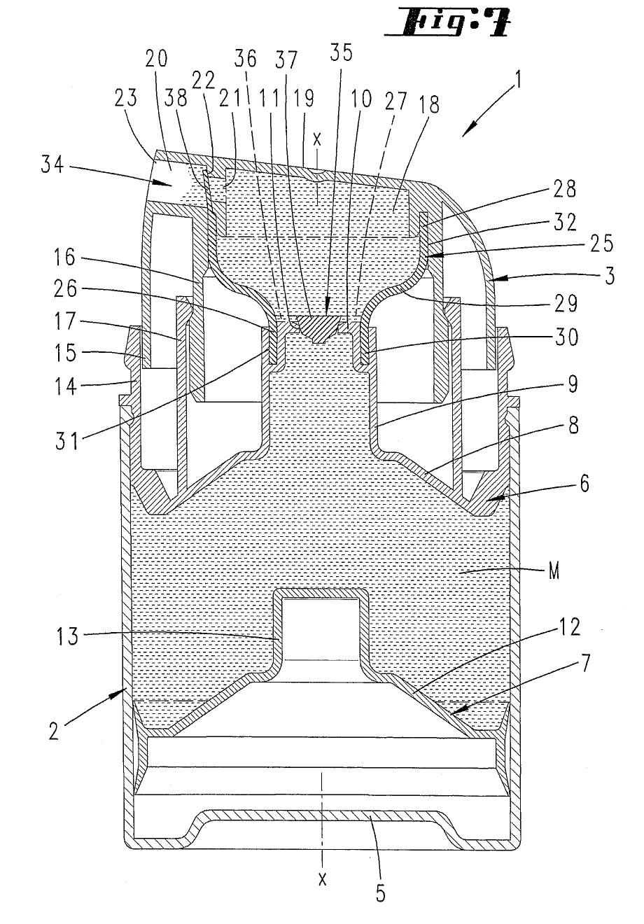

FIG. 7 shows an illustration subsequent to FIG. 6, relating to the headpiece displaced back into the end position after refilling the portioning chamber;

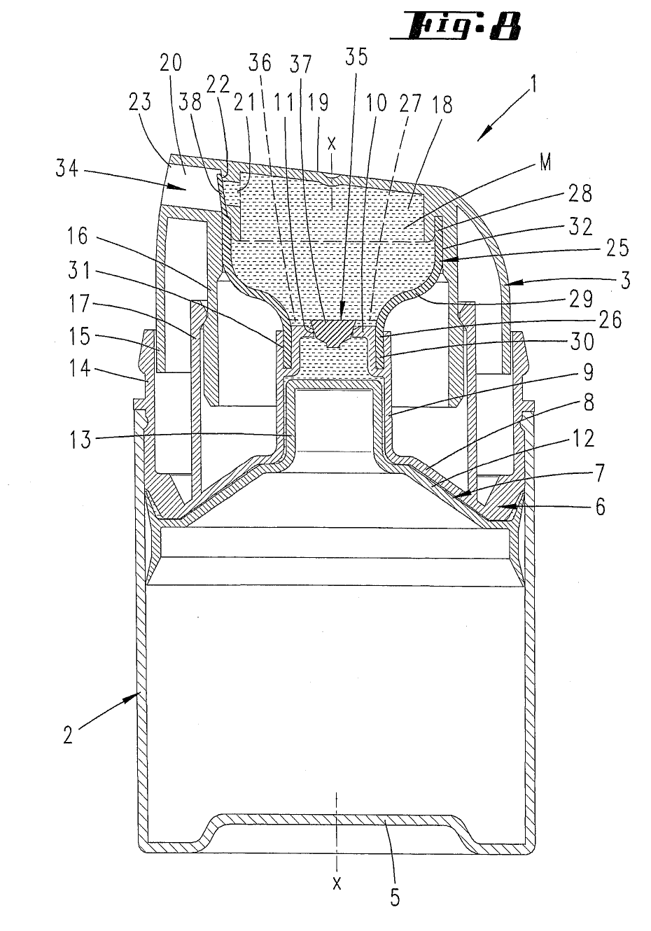

FIG. 8 shows an illustration corresponding to FIG. 7 relating to a situation after emptying the substance housing storing the substance;

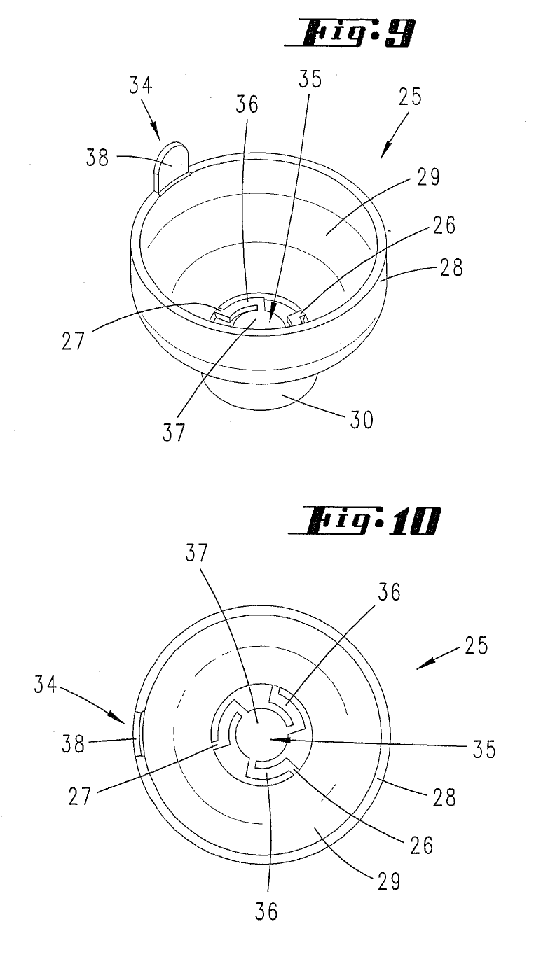

FIG. 9 shows a perspective individual illustration of a return spring element of the dispenser with inlet and outlet valves that are formed as one piece with the return spring element;

FIG. 10 shows the return spring element in a top view.

Illustrated and described, in first instance with reference to FIG. 1, is a dispenser 1 in particular for a pasty substance M, which dispenser 1 is substantially composed of a substance housing 2 storing the substance M, and of an actuatable headpiece 3.

In a preferred and also illustrated configuration, the dispenser 1 is configured to be rotationally symmetric and has a central axis x.

In the unused position of the dispenser 1, the headpiece 3 is preferably covered with a cap 4, as illustrated in the FIGS. 1 and 2. It is further preferred that said cap has an outer diameter that corresponds to the outer diameter of the substance housing 2.

The substance housing 2 has a housing bottom 5. The opening of the substance housing 2, which opening faces vertically upward in the illustrations, is covered by an insert 6 which, in the usual operating state of the dispenser 1, is connected to the substance housing 2 in such a manner that it cannot be detached, at least not without tools, thus is in particular connected by latching.

It is further preferred that a follower plunger 7 is provided in the substance housing 2. Between said follower plunger and the insert 6 covering the upper side of substance housing, the substance M is stored.

Extending from a cone region 8, the insert 6 centrally forms a tube part 9 that protrudes beyond the opening plane of the substance housing 2. In a preferred configuration, said tube part has an inner diameter that corresponds to a third to a fifth, more preferably to a fourth of the inner diameter of the substance housing 2. The top 10 of the tube part has a central inlet opening 11.

Referring to a vertical cross-section through the dispenser 1, the contour of the follower plunger 7 is substantially adapted to the contour of the insert 6 so that accordingly, the follower plunger 7 extending from a cone region 12 also forms a central tube portion 13 which, with regard to the outer diameter, is adapted to the inner diameter of the tube part 9.

Moreover, the insert 6 is preferably designed for fixedly latching the cap 4, for which purpose the insert 6 has a circumferential vertical collar 14 that protrudes beyond the opening plane of the substance housing 2 and interacts in the closed cap position with a circumferential lower edge region of the cap 4 (cf. FIG. 2).

Moreover, the vertical collar 14 also serves for guiding the headpiece 3 in the vertical direction. For this purpose, the vertical collar 14 interacts with an outside of a wall of an annular wall portion 15 of the headpiece 3, which annular wall portion is vertically aligned with regard to the illustrations. Furthermore, this radially outer guidance is associated with a radially inner guidance. Here, an annular wall 16 of the headpiece interacts with an annular collar 17 of the insert 6, which annular collar extends between the tube part 9 and the vertical collar 14.

As a result of the above-described guidance, the headpiece 3 can be displaced in the vertical direction relative to the insert 6 and therefore relative to the substance housing 2 while guided correspondingly, the vertical displacement being limited vertically downwards and also vertically upwards in each case by a limit stop.

The headpiece 3 has a portioning chamber 18. The latter, at least in the unloaded position of the headpiece 3, is substantially disposed above the tube part 9 of the insert or the substance housing. Circumferentially with respect to the axis x, the portioning chamber 18 is substantially bounded by the annular wall 16, which annular wall 16 has a thickening in the region of the portioning chamber 18. The portioning chamber 18 is bounded on the upper side by a headpiece top 19 which, at the same time, provides an operating surface for preferably finger-activated application of pressure on the headpiece 3 for dispensing the substance M.

The portioning chamber 18 at least tends to open substantially radially outwards into a mouthpiece channel 20. For this purpose, the region of the annular wall 16 or its thickening at the headpiece, which region is associated with the mouthpiece channel 20, is provided with an outlet opening 21 formed therein, the diameter of which is reduced with respect to the inner diameter of the mouthpiece channel 20.

It is further preferred that a central axis of the mouthpiece channel 20 runs in parallel alignment with an actuation plane of the headpiece top 19 and, further preferred, as illustrated, encloses an acute angle of 10 to 15° with a plane that extends transverse when viewed in relation to the axis x.

The engagement surface 22 that faces towards the mouth piece channel 20 and surrounds the outlet opening 21 runs, with regard to a vertical cross-section, at an acute angle of 5 to 7° to a vertical plane that runs parallel to the axis x.

It is further preferred that prior to a first use of the dispenser 1, the mouthpiece channel 20 is closed in particular for quality protection by means of a plug 24 that protrudes into the dispense opening 23.

Preferably, all above-described components of the dispenser 1 are molded parts made from a plastics material, in particular a hard plastics material, which components, as further preferred, are produced using the injection molding method.

For a preferably automatic displacement of the headpiece back into the initial position after a vertical downward displacement of the latter required for dispensing the substance, a resilient return spring element 25 is provided. This return spring element serves at the same time as a sealing element for sealing in particular the portioning chamber 18 and thereby forms the chamber bottom located opposite from the headpiece top 19. For this purpose, the return spring element 25 is made from a rubber-like, elastically returnable plastics, more preferably from a silicone material.

The return spring element 25 shown in individual illustrations in FIGS. 9 and 10 is first and foremost configured in a substantially rotationally symmetric manner and, in first instance, has in its center a pot-shaped fixation portion 26 with a top 27 that is aligned transverse to the axis x in the mounted state, and with a circumferential wall that extends from the top 27 and faces downwards. Extending from this circumferential wall, the return spring element 25 widens in a pot-like manner thereby forming in the mounted state a vertically upper ring-shaped end portion 28, which, with regard to a vertical section according to FIG. 5, is connected to the downwardly facing circumferential wall via a curved S-shaped middle portion 29. In the region of the vertically upper end portion 28, the return spring element 25 preferably has an inner diameter that corresponds to the 1.5- to 3-fold, more preferably to the 2-fold of the inner diameter in the region of the downwardly facing wall which represents the lower end portion 30 of the return spring element 25.

The return spring element 25 is held in the region of the tube part top 10, for which purpose the end portion 30 engages in a circumferential annular slot 31 of the tube part 9 and is clamped therein. The vertically upwards facing circumferential end portion 28 of the return spring element 25 is securely clamped in a circumferential annular groove 32 in the region of the thickening of the annular wall 16 of the headpiece.

In an operationally unloaded basic position of the return spring element 25, for example according to the illustration in FIG. 2, the middle portion 29 extends in vertical alignment between the circumferential wall of the tube part 9 and the annular wall 16 of the headpiece 3. This middle portion 29 buckles in the course of the downward displacement of the headpiece 3 as a result of the pressure acting on the headpiece top 19, the curved S-shape of the return spring element wall, in particular of the middle portion 29, transitioning into the shape of two oppositely oriented U-portions 33, 33′ (cf. e.g. FIG. 3). The return spring element 25 acts corresponding to a telescopic bellows. In the course of a user-actuated downward displacement of the headpiece 3, as spring force is built up via the telescopic-bellows-like return spring element 25, which spring force is used for automatically returning the headpiece 3 into the initial position after releasing the pressure load from the outside. The force acting here in the course of the return is directed substantially parallel to the direction of displacement.

In the course of the downward displacement of the headpiece 3 caused by pressure application, the middle portion 29 moves telescopically into the region of the portioning chamber 18 thereby forming the U-portion 33; this preferably takes place while correspondingly supporting the substance dispensation from the portioning chamber 18. The oppositely oriented U-portion 33 moves telescopically into the free annular chamber between the wall of the tube part 9 and the annular wall 16 at the headpiece.

In an advantageous configuration, the return spring element 25 is formed as one piece from a single material with both an outlet valve 34 and an inlet valve 35. With regard to the inlet valve 35, this is a substantially disc-shaped valve in the region of the top 27 of the fixation portion 26, which valve has a centrally disposed conical cover body 37 that is movably carried by webs 36. In a basic position of the dispenser 1, the conical cover body sealingly closes the inlet opening 11 of the tube part 9 on the side of the substance housing, the webs 36 carrying the conical cover body 37 being substantially supported, at least partially, on the upper side of the tube part top 10.

The outlet valve 34 operates alternately with the inlet valve 34. The outlet valve is formed as a pivotable cover tongue 38 which protrudes, with regard to a vertical section, in extension of the end portion 30 from the circumferential edge formed by the vertically upper end portion 30. This cover tongue 38 has a material thickness that is reduced with respect to the end portion 30 carrying said cover tongue and preferably has a material thickness that corresponds to the 0.5- to 0.8-fold of the material thickness of the end portion 30.

Through a slot formed in the connection region of the end portion 30 in the region of the thickening of the annular wall 16, the cover tongue 38 extends into the mouthpiece channel 20 to bring the sealing surface facing towards the outlet opening 21 into engagement on the engagement surface 22 surrounding the outlet opening 21. Accordingly, as a result of the acute angulation of the engagement surface 22, the cover tongue 38, with respect to the unloaded orientation of the cover tongue 38 in the non-mounted state, is resiliently loaded in the direction toward the closing position of the outlet opening 21.

FIGS. 3 to 5 illustrate positions of the dispenser 1 in the course of a first use. It is shown that, according to the illustration in FIG. 3, prior to a first use, the substance M is contained only in the substance housing 2. Accordingly, in first instance, a first filling of the portioning chamber 18 is to be made. This is carried out by usual actuation of the headpiece 3 in that as a result of pressure application, the latter is displaced downwards in the direction of the arrow P relative to the substance housing 2, this, furthermore, taking place against the force of the return spring element 25, which, after releasing the pressure load, effects automatically a return movement of the of the headpiece 3 into the initial position. In the course of this displacement back into the initial position and while the inlet valve 35 or the conical cover body 37 is correspondingly displaced into a position that uncovers the inlet opening 11, substance M is sucked into the portioning chamber 18. For complete filling of the portioning chamber 18 according to the illustration in FIG. 5, it is preferably needed to actuate the headpiece 3 (pump actuation) 2 to 3 times.

Thereafter, the dispenser is ready for the first apportioned dispensation of substance M.

Such apportioned substance dispensation is illustrated in FIG. 6. As a result of the pressure application in the direction of the arrow P with corresponding lowering of the headpiece 3 and due to an associated pressure increase in the portioning chamber 18, the substance M, while pressing against the cover tongue 38 of the of the outlet valve 34 and pivotably displacing it, is transported through the outlet opening 21 and the mouthpiece channel 20 to the outside to be dispensed in the region of the dispense opening 23. Here, the cover tongue 38 bends into the flow of the substance M, this bending, as further preferred, begins at the bottom of the connection region to the edge 33 of the return spring element 25, thereby causing an arc-shaped deflection, as viewed in a vertical section.

In doing so, preferably, a dispensed substance volume of 0.8 to 1.5 ml is achieved.

The vertically lowest position of the headpiece 3, as described, is limited by a limit stop. The spring force of the return spring element 25 built up during the downward displacement of the headpiece 3 is used for automatically displacing the headpiece 3 back into the initial position of the headpiece 3 illustrated in FIG. 6, the portioning chamber 18 being refilled with substance M due to the suction effect occurring in the course of the back-displacement, this taking place while the outlet valve 34 is correspondingly displaced into the release position. At the same time, since the flow no longer acts on the cover tongue 38, the cover tongue, due to its biased mounting position, is displaced back into the closing position of the outlet opening 21, which displacement is further supported as a result of the suction effect occurring during the back-displacement, which suction effect advantageously also brings about that substance M remaining in the mouthpiece channel 20 is at least partially sucked in. This suction-induced back-displacement of the substance residues M remaining in the mouthpiece channel 20 supports the back-displacement of the cover tongue 38 into the closing position.

FIG. 8 shows the emptying position of the dispenser 1, in which the plunger 7 trailing in the course of the individual dispense actuations comes into a stop position with the insert 6, the tube portion 13 of the follower piston thereby plunging into the tube part 9. FIG. 8 shows a position in which the portioning chamber 18 is still completely filled and accordingly still allows dispensing an apportioned amount of substance M. When empty, the proposed dispenser 1 shows a small residual amount of preferably less than 2.6 ml.

All features disclosed are (in themselves) pertinent to the invention. The disclosure content of the associated/accompanying priority documents (copy of the prior application) is also hereby included in full in the disclosure of the application, including for the purpose of incorporating features of these documents in claims of the present application. The subsidiary claims in their optional subordinated formulation characterize independent inventive refinement of the prior art, in particular to undertake divisional applications based on these claims.

### REFERENCE LIST

1 Dispenser

2 Substance housing

3 Headpiece

4 Cap

5 Housing bottom

6 Insert

7 Follower plunger

8 Cone region

9 Tube part

10 Tube part top

11 Inlet opening

12 Cone region

13 Tube portion

14 Vertical collar

15 Annular wall portion

16 Annular wall

17 Annular collar

18 Portioning chamber

19 Headpiece top

20 Mouthpiece channel

21 Outlet opening

22 Engagement surface

23 Dispense opening

24 Plug

25 Return spring element

26 Fixation portion

27 Top

28 End portion

29 Middle portion

30 End portion

31 Annular slot

32 Annular groove

33 U-portion

33′ U-portion

34 Outlet valve

35 Inlet valve

36 Web

37 Conical cover body

38 Cover tongue

x Axis

M Substance

P Pressure

1. A dispenser (1) for pasty substances (11), consisting of a tubular substance housing (2) having a follower plunger (7) and a hand-actuatable headpiece (3) which is equipped with a mouthpiece and is linearly guided for dispensing the substance and can be depressed in the direction of the follower plunger (7) while tensioning a return spring element (25) that structures itself by buckling, wherein the middle portion (29) of the resilient return spring element (25) folds up into the portioning chamber (18) of the headpiece (3), the return spring element (25) transitioning from a curved S-shape into the shape of two oppositely oriented U-portions (33, 33′), and the two end portions (28, 30) being clamped at the headpiece (3) and an upper tube part (9) of the substance housing (2).

2. The dispenser according to claim 1, wherein
the outer end portion (28) of the return spring element (25) that folds up from the S-shape extends further so as to form a cover tongue (38) for an outlet opening (21) between the portioning chamber (18) at the headpiece and the outlet mouthpiece, for forming an outlet valve (34).

3. The dispenser according to claim 1, wherein the cover tongue (38) is resiliently loaded in the direction of the outlet opening (21) between the portioning chamber (18) and the outlet mouthpiece.

4. The dispenser according to claim 1, wherein an inlet valve (35) is provided that operates alternately with the outlet valve (34) and opens during a suction stroke of the headpiece (3) so as to fill the portioning chamber (18), and that the inlet valve (35) is formed as one piece with the return spring element (25).

5. The dispenser according to claim 1, wherein the return spring element (25) consists of rubber-like, elastically returnable plastics.
